(19) United States
(12) Patent Application Publication
(10) Pub. No.: US 2025/0356577 A1
(43) Pub. Date: Nov. 20, 2025

(54) SYSTEMS, METHODS, AND MEDIA FOR GENERATING POINT CLOUD FRAME TRAINING DATA

(71) Applicant: HUAWEI TECHNOLOGIES CO., LTD., Shenzhen (CN)

(72) Inventors: Yuan REN, Kanata (CA); Chenqi LI, Kanata (CA); Bingbing LIU, Shenzhen (CN)

(21) Appl. No.: 19/281,163

(22) Filed: Jul. 25, 2025

Related U.S. Application Data
(63) Continuation of application No. PCT/CN2023/073563, filed on Jan. 28, 2023.

(51) Int. Cl. G06T 15/08; G06T 15/06

(52) U.S. Cl. CPC G06T 15/08; G06T 15/06; G06T 2210/56

(57) ABSTRACT

Methods, systems, and media for generating point cloud frame training data are provided. First domain point cloud data comprising a point cloud frame corresponding to a first LiDAR sensor configuration is obtained. For each ray, a pixel of a range image is generated by selecting a set of points from the first domain point cloud data based on a certain threshold distance of the points to the ray, a first peak of the pixel is identified as a subset of the set of points based on a distance value of each point in the subset, and the subset of points is processed using an averaging function to generate estimated reflectance data for the ray. The estimated reflectance data of each ray of the plurality of rays is processed to generate simulated second domain point cloud data comprising a point cloud frame corresponding to the second LiDAR sensor configuration.

### CROSS-REFERENCE TO RELATED APPLICATIONS

This application is a continuation of P.C.T. Application No. PCT/CN2023/073563 filed on Jan. 28, 2023, the entire contents of which are incorporated herein by reference.

### TECHNICAL FIELD

The present application generally relates to machine learning, and, in particular, to systems, methods, and media for generating point cloud frame training data.

### BACKGROUND

A Light Detection And Ranging (LiDAR, also referred to a “Lidar” or “LIDAR” herein) sensor generates point cloud data representing a 3D environment (also called a “scene”) scanned by the LIDAR sensor. A single scanning pass of the LIDAR sensor generates a “frame” of point cloud data (referred to hereinafter as a “point cloud frame”), consisting of a set of points in space from which light is reflected, within a time period representing the time it takes the LIDAR sensor to perform one scanning pass. Some LIDAR sensors, such as spinning scanning LIDAR sensors, include a laser array that rotates and emits light in an arc to generate a point cloud frame. Other LIDAR sensors, such as solid-state LIDAR sensors, include a laser array that emits light from one or more positions and integrates reflected light detected to form a point cloud frame. Each laser in the laser array is used to generate multiple points per scanning pass, and each point in a point cloud frame corresponds to an object reflecting light emitted by a laser at a point in the environment. Each point is typically stored as a set of spatial coordinates (X, Y, Z) as well as other data indicating values such as intensity (i.e., the degree of reflectivity of the object reflecting the laser). The other data may be represented as an array of values in some implementations. In a scanning spinning LIDAR sensor, the Z axis of the point cloud frame is typically defined by the axis of rotation of the LIDAR sensor, roughly orthogonal to an azimuth direction of each laser in most cases (although some LIDAR sensors may angle some of the lasers slightly up or down relative to the plane orthogonal to the axis of rotation).

Point cloud data frames may also be generated by other scanning technologies, such as high-definition radar or depth cameras, and theoretically any technology using scanning beams of energy, such as electromagnetic or sonic energy, could be used to generate point cloud frames. Whereas examples will be described herein with reference to LIDAR sensors, it will be appreciated that other sensor technologies which generate point cloud frames could be used in some embodiments.

A LIDAR sensor is one of the primary sensors used in autonomous vehicles to sense an environment (i.e., scene) surrounding the autonomous vehicle. An autonomous vehicle generally includes an automated driving system (ADS) or advanced driver-assistance system (ADAS). The ADS or the ADAS includes a perception submodule that processes point cloud frames to generate predictions which are usable by other sub-systems of the ADS or ADAS for localization, path planning, motion planning, or trajectory generation for the autonomous vehicle.

However, because of the sparse and unordered nature of point cloud frames, the cost of collecting and labeling point cloud frames at the point level is time consuming and expensive. Points in a point cloud frame must be clustered, segmented, or grouped (e.g., using object detection, semantic segmentation, instance segmentation, or panoptic segmentation) such that a collection of points in the point cloud frame may be labeled with an object class (e.g., “pedestrian” or “motorcycle”) or an instance of an object class (e.g. “pedestrian #3”), with these labels being used in machine learning to train models for prediction tasks on point cloud frames, such as object detection or various types of segmentation. This cumbersome process of labeling has resulted in limited availability of labeled point cloud frames representing various road and traffic scenes, which are needed to train high accuracy models for prediction tasks on point cloud frames using machine learning.

Additionally, changing the LIDAR sensor or the positioning of the LIDAR sensor on the vehicle changes the collected point cloud data frame, and creates a domain gap that cannot be generalized by object detection models. Instead, new data must be collected and annotated. This data may not be easily collected in the real world through traditional means. For example, if the object being detected was previously unseen, the detection algorithm models will miss the object. As a result, in order to properly train the model, new training data with the previously unseen object must be gathered to properly augment the model. Difficulty can arise when data must be gathered for objects that are rare to find, and testing the vehicle's performance in previous failure cases with the new training data can be dangerous in the real world, as there is no guarantee that the detection models will navigate successfully.

In order to generate more realistic sensor data for training the detection models, physics engines can be used to generate simulated sensor data in a 3D constructed environment. However, constructing the 3D environment to simulate this data requires significant human intervention, and cannot be automated at a meaningful scale. Further, the generated simulation data is typically too idealized, and does not contain some of the imperfections present in real simulation data, such as jagged edges or incomplete outlines. As a result, the model trained on the simulation data does not achieve the same level of performance when tasked with navigating the real world, as the real data does not resemble the training data closely enough. This problem can be partially addressed by generating the 3D environment and the object library from real collected sensor data, and using the generated simulation data in conjunction with the real collected sensor data.

One existing approach that utilizes real data to do 3D environment reconstruction is found in M. Sivabalan, S. Wang, K. Wong, W. Zeng, M. Sazanovich, S. Tan, Shuhan, B. Yang, W. Ma, R. Urtasun, “LIDARsim: Realistic LiDAR Simulation by Leveraging the Real World”. This approach uses a vehicle with a localization system and a spinning scan LIDAR to collect real world data from a road segment. A surface element map is generated using 3D construction, and vehicles are extracted at the same time from the scan data. A 3D object bank is generated from the collected data using the symmetry hypothesis and an iterative closest point algorithm. The LIDAR point cloud is simulated with a raycasting algorithm, which finds the intersection between the laser rays and the surface elements. The raycasting can be done by utilizing open source code such as Intel Embree or Nvidia OptiX. Lastly, a UNet is implemented on the range image of the simulated point cloud to drop points that are typically not found on a real LIDAR point cloud.

However, this solution has four key disadvantages. Firstly, the raycasted simulation frames contain lots of noise, which thickens the surface of the objects. This leads to inaccurate object models, and lowers the overall accuracy of the system. Additionally, the odometry localization is inaccurate, which leads to imperfect alignments of frames to build a map. The point cloud also contains noise points due to ego motion and imperfect sensor alignment. Secondly, the same object generates different intensity values when it is observed from different angles and distances. This creates a noisy intensity map within a single scanning ring when given information from the surface element first hit by the ray. Third, this raycasting method is only suitable for spinning scan LIDAR, and cannot work to simulate LIDARs with irregular scanning patterns. Finally, the UNET raydrop model is specific only to the related environment. For example, a UNet that is trained in one city cannot be directly used in another city due to the domain gap between the two differing environments.

A second approach to addressing the 3D environmental reconstruction problem is outlined in F. Langer, A. Milioto, A. Haag, J. Behley and C. Stachniss, “Domain Transfer for Semantic Segmentation of LIDAR Data using Deep Neural Networks”. In this approach, data is collected from a Velodyne HDL-64 and is used to train a semantic segmentation algorithm which takes the Velodyne NDL-32 LIDAR as input data. The 3D reconstruction is done with the labeled data, and the simulation data is generated through raycasting. The 3D reconstruction result is represented by a dense point cloud and 3D mesh. The simulation point cloud is generated using the closest point and collision detection raycasting method.

This approach also has disadvantages. First, the raycasted simulation frames are noisy, and the single frame point cloud is also prone to noise. Using the closest point to generate the simulation frame will pick up the generated noise points. Secondly, a mesh-based simulation frame generation leads to distortion of the map geometry, which creates a worse sensor domain transfer performance.

### SUMMARY

In accordance with a first aspect of the present disclosure, there is provided a method for generating point cloud frame training data, comprising: obtaining first domain point cloud data comprising a point cloud frame corresponding to a first LiDAR sensor configuration; generating a plurality of rays representative of laser trajectories of a second LiDAR sensor configuration; for each ray: generating a pixel of a range image by selecting a set of points from the first domain point cloud data based on a certain threshold distance of the points to the ray; identifying a first peak of the pixel as a subset of the set of points based on a distance value of each point in the subset; and processing the subset of points, using an averaging function, to generate estimated reflectance data for the ray; and processing the estimated reflectance data of each ray of the plurality of rays to generate simulated second domain point cloud data comprising a point cloud frame corresponding to the second LiDAR sensor configuration.

In some or all examples of the first aspect, the point cloud frame of the first domain point cloud data is a dense point cloud frame, and obtaining the first domain point cloud data comprises: obtaining raw first domain point cloud data comprising a raw point cloud frame corresponding to a first LiDAR sensor configuration; and densifying the raw first domain point cloud data to generate the first domain point cloud data.

In some or all examples of the first aspect, densifying the raw first domain point cloud data comprises constructing a 3D environment based on the raw first domain point cloud data.

In some or all examples of the first aspect, identifying the first peak comprises: identifying a first point based on the proximity of the first point to the ray and the distance value of the first point; and identifying a last point of the first peak based on the proximity of the last point to the ray and the distance value of the last point.

In some or all examples of the first aspect, the averaging function comprises a weighted average function based on an inverse distance weighting function wherein each point in the subset is associated with a weight inversely correlated with the proximity of the point to the ray.

In some or all examples of the first aspect, the method further comprises: processing the first domain point cloud data and the simulated second domain point cloud data to generate voxelized data comprising coordinate values and intensity values for each point of the first domain point cloud data and each point of the simulated second domain point cloud data found in each of a plurality of voxels; obtaining, for each voxel, a retained point ratio comprising the ratio of points in the first domain point cloud data to the points in the simulated second domain point cloud data; and generating a refined simulated point cloud frame comprising a plurality of points of the simulated second domain point cloud data gathered from voxels having a retained point ratio higher than a pre-determined threshold.

In some or all examples of the first aspect, the coordinate values comprise an angle value and a distance value for each point, and the surface reflectance values comprise an intensity value for each point.

In some or all examples of the first aspect, processing the first domain point cloud data and the simulated second domain point cloud data to generate the voxelized data comprises projecting the points from the first domain point cloud data and the points from the simulated second domain point cloud data into an input parameter space, wherein the parameter space comprises possible parameter values that define a mathematical model.

In some or all examples of the first aspect, processing the first domain point cloud data and the simulated second domain point cloud data to generate the voxelized data further comprises voxelizing the input parameter space.

In some or all examples of the first aspect, generating the refined simulated point cloud frame comprises approximating a distribution of a retained point ratio of each voxel by a multi-layer perceptron.

In some or all examples of the first aspect, the approximated distribution of the retained point ratio comprises only voxels that have a number of LiDAR simulated point cloud points above a pre-determined threshold.

In a second aspect of the present disclosure, there is provided a method for generating point cloud frame training data, comprising: obtaining a real LiDAR point cloud and a simulated LiDAR point cloud, each comprising coordinate values and surface reflectance values for each of a plurality of points; processing the real LiDAR point cloud and the simulated LiDAR point cloud to generate voxelized data comprising coordinate values and intensity values for each point of the real LiDAR point cloud and each point of the simulated LiDAR point cloud found in each of a plurality of voxels; obtaining, for each voxel, a retained point ratio comprising the ratio of points in the real LiDAR point cloud frame to the points in the simulated LiDAR point cloud frame; and generating a refined simulated LiDAR simulation point cloud frame comprising a plurality of points of the simulated point cloud frame gathered from voxels having a retained point ratio higher than a pre-determined threshold.

In some or all examples of the second aspect, the coordinate values comprise an angle value and a distance value for each point, and the surface reflectance values comprise an intensity value for each point.

In some or all examples of the second aspect, processing the real LiDAR point cloud and the simulated LiDAR point cloud to generate the voxelized data comprises projecting the points from the real LiDAR point cloud and the points from the simulated LiDAR point cloud into an input parameter space, wherein the parameter space comprises possible parameter values that define a mathematical model.

In some or all examples of the second aspect, processing the real LiDAR point cloud and the simulated LiDAR point cloud to generate the voxelized data further comprises voxelizing the input parameter space.

In some or all examples of the second aspect, generating the refined simulated LiDAR simulation point cloud frame comprises approximating a distribution of a retained point ratio of each voxel by a multi-layer perceptron.

In some or all examples of the second aspect, the approximated distribution of the retained point ratio comprises only voxels that have a number of LiDAR simulated point cloud points above a pre-determined threshold.

In a third aspect of the present disclosure, there is provided a system for generating point cloud frame training data, comprising: one or more processors; and a memory storing an initial point cloud, and machine-executable instructions which, when executed by the one or more processors, cause the system to: obtain first domain point cloud data comprising a point cloud frame corresponding to a first LiDAR sensor configuration; generate a plurality of rays representative of laser trajectories of a second LiDAR sensor configuration; for each ray; generate a pixel of a range image by selecting a set of points from the first domain point cloud data based on a certain threshold distance of the points to the ray; identify a first peak of the pixel as a subset of the set of points based on a distance value of each point in the subset; and process the subset of points, using an averaging function, to generate estimated reflectance data for the ray; and process the estimated reflectance data of each ray of the plurality of rays to generate simulated second domain point cloud data comprising a point cloud frame corresponding to the second LiDAR sensor configuration.

In some or all examples of the third aspect, the point cloud frame of the first domain point cloud data is a dense point cloud frame, and obtaining the first domain point cloud data comprises: obtaining raw first domain point cloud data comprising a raw point cloud frame corresponding to a first LiDAR sensor configuration; and densifying the raw first domain point cloud data to generate the first domain point cloud data.

In some or all examples of the third aspect, densifying the raw first domain point cloud data comprises constructing a 3D environment based on the raw first domain point cloud data.

In some or all examples of the third aspect, identifying the first peak comprises: identifying a first point based on the proximity of the first point to the ray and the distance value of the first point; and identifying a last point of the first peak based on the proximity of the last point to the ray and the distance value of the last point.

In some or all examples of the third aspect, the averaging function comprises a weighted average function based on an inverse distance weighting function wherein each point in the subset is associated with a weight inversely correlated with the proximity of the point to the ray.

In some or all examples of the third aspect, the system is configured to: process the first domain point cloud data and the simulated second domain point cloud data to generate voxelized data comprising coordinate values and intensity values for each point of the first domain point cloud data and each point of the simulated second domain point cloud data found in each of a plurality of voxels; obtain, for each voxel, a retained point ratio comprising the ratio of points in the first domain point cloud data to the points in the simulated second domain point cloud data; and generate a refined simulated point cloud frame comprising a plurality of points of the simulated second domain point cloud data gathered from voxels having a retained point ratio higher than a pre-determined threshold.

In some or all examples of the third aspect, the coordinate values comprise an angle value and a distance value for each point, and the surface reflectance values comprise an intensity value for each point.

In some or all examples of the third aspect, processing the first domain point cloud data and the simulated second domain point cloud data to generate the voxelized data comprises projecting the points from the first domain point cloud data and the points from the simulated second domain point cloud data into an input parameter space, wherein the parameter space comprises possible parameter values that define a mathematical model.

In some or all examples of the third aspect, processing the first domain point cloud data and the simulated second domain point cloud data to generate the voxelized data further comprises voxelizing the input parameter space.

In some or all examples of the third aspect, generating the refined simulated point cloud frame comprises approximating a distribution of a retained point ratio of each voxel by a multi-layer perceptron.

In some or all examples of the third aspect, the approximated distribution of the retained point ratio comprises only voxels that have a number of LiDAR simulated point cloud points above a pre-determined threshold.

In a fourth aspect of the present disclosure, there is provided a system for generating point cloud frame training data, comprising: one or more processors; and a memory storing machine-executable instructions which, when executed by the one or more processors, cause the system to: obtain a real LiDAR point cloud and a simulated LiDAR point cloud, each comprising coordinate values and surface reflectance values for each of a plurality of points; process the real LiDAR point cloud and the simulated LiDAR point cloud to generate voxelized data comprising coordinate values and intensity values for each point of the real LiDAR point cloud and each point of the simulated LiDAR point cloud found in each of a plurality of voxels; obtain, for each voxel, a retained point ratio comprising the ratio of points in the real LiDAR point cloud frame to the points in the simulated LiDAR point cloud frame; and generate a refined simulated LiDAR simulation point cloud frame comprising a plurality of points of the simulated point cloud frame gathered from voxels having a retained point ratio higher than a pre-determined threshold.

In some or all examples of the fourth aspect, the coordinate values comprise an angle value and a distance value for each point, and the surface reflectance values comprise an intensity value for each point.

In some or all examples of the fourth aspect, processing the real LiDAR point cloud and the simulated LiDAR point cloud to generate the voxelized data comprises projecting the points from the real LiDAR point cloud and the points from the simulated LiDAR point cloud into an input parameter space, wherein the parameter space comprises possible parameter values that define a mathematical model.

In some or all examples of the fourth aspect, processing the real LiDAR point cloud and the simulated LiDAR point cloud to generate the voxelized data further comprises voxelizing the input parameter space.

In some or all examples of the fourth aspect, generating the refined simulated LiDAR simulation point cloud frame comprises approximating a distribution of a retained point ratio of each voxel by a multi-layer perceptron.

In some or all examples of the fourth aspect, the approximated distribution of the retained point ratio comprises only voxels that have a number of LiDAR simulated point cloud points above a pre-determined threshold.

In a fifth aspect of the present disclosure, there is provided a non-transitory machine-readable medium having tangibly stored thereon executable instructions for execution by one or more processors, wherein the executable instructions, in response to execution by the one or more processors, cause the one or more processors to: obtain first domain point cloud data comprising a point cloud frame corresponding to a first LiDAR sensor configuration; generate a plurality of rays representative of laser trajectories of a second LiDAR sensor configuration; for each ray; generate a pixel of a range image by selecting a set of points from the first domain point cloud data based on a certain threshold distance of the points to the ray; identify a first peak of the pixel as a subset of the set of points based on a distance value of each point in the subset; and process the subset of points, using an averaging function, to generate estimated reflectance data for the ray; and process the estimated reflectance data of each ray of the plurality of rays to generate simulated second domain point cloud data comprising a point cloud frame corresponding to the second LiDAR sensor configuration.

In some or all examples of the fifth aspect, the point cloud frame of the first domain point cloud data is a dense point cloud frame, and obtaining the first domain point cloud data comprises: obtaining raw first domain point cloud data comprising a raw point cloud frame corresponding to a first LiDAR sensor configuration; and densifying the raw first domain point cloud data to generate the first domain point cloud data.

In some or all examples of the fifth aspect, densifying the raw first domain point cloud data comprises constructing a 3D environment based on the raw first domain point cloud data.

In some or all examples of the fifth aspect, identifying the first peak comprises: identifying a first point based on the proximity of the first point to the ray and the distance value of the first point; and identifying a last point of the first peak based on the proximity of the last point to the ray and the distance value of the last point.

In some or all examples of the fifth aspect, the averaging function comprises a weighted average function based on an inverse distance weighting function wherein each point in the subset is associated with a weight inversely correlated with the proximity of the point to the ray.

In some or all examples of the fifth aspect, the system is configured to: process the first domain point cloud data and the simulated second domain point cloud data to generate voxelized data comprising coordinate values and intensity values for each point of the first domain point cloud data and each point of the simulated second domain point cloud data found in each of a plurality of voxels; obtain, for each voxel, a retained point ratio comprising the ratio of points in the first domain point cloud data to the points in the simulated second domain point cloud data; generate a refined simulated point cloud frame comprising a plurality of points of the simulated second domain point cloud data gathered from voxels having a retained point ratio higher than a pre-determined threshold.

In some or all examples of the fifth aspect, the coordinate values comprise an angle value and a distance value for each point, and the surface reflectance values comprise an intensity value for each point.

In some or all examples of the fifth aspect, processing the first domain point cloud data and the simulated second domain point cloud data to generate the voxelized data comprises projecting the points from the first domain point cloud data and the points from the simulated second domain point cloud data into an input parameter space, wherein the parameter space comprises possible parameter values that define a mathematical model.

In some or all examples of the fifth aspect, processing the first domain point cloud data and the simulated second domain point cloud data to generate the voxelized data further comprises voxelizing the input parameter space.

In some or all examples of the fifth aspect, generating the refined simulated point cloud frame comprises approximating a distribution of a retained point ratio of each voxel by a multi-layer perceptron.

In some or all examples of the fifth aspect, the approximated distribution of the retained point ratio comprises only voxels that have a number of LiDAR simulated point cloud points above a pre-determined threshold.

In a sixth aspect of the present disclosure, there is provided a non-transitory machine-readable medium having tangibly stored thereon executable instructions for execution by one or more processors, wherein the executable instructions, in response to execution by the one or more processors, cause the one or more processors to: obtain a real LiDAR point cloud and a simulated LiDAR point cloud, each comprising coordinate values and surface reflectance values for each of a plurality of points; process the real LiDAR point cloud and the simulated LiDAR point cloud to generate voxelized data comprising coordinate values and intensity values for each point of the real LiDAR point cloud and each point of the simulated LiDAR point cloud found in each of a plurality of voxels; obtain, for each voxel, a retained point ratio comprising the ratio of points in the real LiDAR point cloud frame to the points in the simulated LiDAR point cloud frame; and generate a refined simulated LiDAR simulation point cloud frame comprising a plurality of points of the simulated point cloud frame gathered from voxels having a retained point ratio higher than a pre-determined threshold.

In some or all examples of the sixth aspect, the coordinate values comprise an angle value and a distance value for each point, and the surface reflectance values comprise an intensity value for each point.

In some or all examples of the sixth aspect, processing the real LiDAR point cloud and the simulated LiDAR point cloud to generate the voxelized data comprises projecting the points from the real LiDAR point cloud and the points from the simulated LiDAR point cloud into an input parameter space, wherein the parameter space comprises possible parameter values that define a mathematical model.

In some or all examples of the sixth aspect, processing the real LiDAR point cloud and the simulated LiDAR point cloud to generate the voxelized data further comprises voxelizing the input parameter space.

In some or all examples of the sixth aspect, generating the refined simulated LiDAR simulation point cloud frame comprises approximating a distribution of a retained point ratio of each voxel by a multi-layer perceptron.

In some or all examples of the sixth aspect, the approximated distribution of the retained point ratio comprises only voxels that have a number of LiDAR simulated point cloud points above a pre-determined threshold.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

Reference will now be made, by way of example, to the accompanying drawings which show example embodiments of the present application, and in which:

FIG. 1A shows a portion of an exemplary LiDAR environment scan forming a pixel of a range image for a point cloud frame of an environment.

FIG. 1B shows the resulting range image including the pixel being captured in FIG. 1A.

FIG. 2 shows points of the point cloud frame for the pixel being captured in FIG. 1A.

FIG. 3 shows the pixel of the range image of FIG. 1B using the points in the first peak.

FIG. 4 is a flowchart illustrating steps of an exemplary method for first peak averaging raycasting that may be performed by a system for generating point cloud frame training data in accordance with an embodiment.

FIG. 5 is an exemplary bar graph showing the density of points in a scan based on distance away from the LiDAR sensor.

FIG. 6 is a flowchart illustrating steps of an exemplary method for raydropping using a surrogate model of the laser head performed by a system for generating point cloud frame training data in accordance with an embodiment.

FIG. 7 is a visualization of a voxel in the input parameter space as determined in FIG. 6.

FIG. 8 is a block diagram showing various physical and logical components of a computing system for generating point cloud frame training data.

Similar reference numerals may have been used in different figures to denote similar components. Unless otherwise specifically noted, articles depicted in the drawings are not necessarily drawn to scale.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

The present disclosure describes devices, systems, methods, and media for generating point cloud frame training data using first peak averaging ray casting and weighted ray dropping. The simulated 3D environments are used as training data for training AI systems for autonomous vehicles. Exemplary devices, systems, methods, and media described herein may transform a dense point cloud gathered from data in one domain, which is then analyzed and transformed into a simulated point cloud in a second domain. This second domain point cloud may then be used as training data for improving the detection models.

In the present disclosure, the term “raycasting” refers to a method by which virtual light rays are “cast” on their path from the focal point of a camera through each pixel in the camera sensor to determine what is visible along the ray in a 3D scene.

Example devices, systems, methods, and media described herein may reduce noise in the simulation result by reducing the error of the 3D reconstruction. Noise can be caused by errors in the calibration of sensors, localization errors, and synchronization errors. However, the methods and systems described herein may modify the 3D reconstruction result and reduce the noise generated during raycasting.

Example devices, systems, methods, and media described herein generate a surrogate model of a laser head which is trained using the raycasting result and the real LIDAR point cloud, rather than using a UNet based method for dropping rays. The surrogate model generated is independent of the environment used to create the model, and thus can be used in any environment after sufficient training.

Example methods and systems described herein may perform the following sequence of operations to raycast using first peak averaging. First, the first domain point cloud is obtained corresponding to a LIDAR sensor configuration. Rays are then cast onto the point cloud which are representative of a second LIDAR configuration. This dense point cloud map is projected into a range image, where all of the points in each pixel of the range image are kept. Due to the error of 3D construction, each pixel will have a thickness of points in the pixel. Next, a first peak in each pixel is detected, and all points which do not lie in the detected first peak are removed. The inverse distance weight of each point is calculated in reference to the ray being cast through each pixel. These inverse distance weights may contain information relating to the coordinates, intensity, and other features of the ray.

Example methods and systems described herein may perform the following sequence of operations to create the surrogate model of the laser head for raydropping. First, all points in a certain number of frames in both the real and simulated LIDAR point clouds are collected with information values relating to coordinates and intensity. This pair of real and simulated point clouds have the same LIDAR pose. The intensity value contains partial information relating to surface reflectance. These points are projected into the input parameter space, which is then voxelized. For each voxel in the input parameter space, a ratio of the real points to simulated points is obtained. A distribution of the ratio is approximated for each voxel in the input parameter space, which is then used as a surrogate model. All points with a ratio lower than a pre-determined threshold are dropped.

Some examples of the method and systems described herein may exhibit advantages over existing approaches. The generated ray casting results are non-repetitive for any number of beams raycast through each pixel. The raycasting removes most of the noise in the dense point cloud map. Many inputs can be added to the surrogate model of the laser head to simulate complex physical models. The surrogate model is environmentally independent and can be used in different environments and customized by changing the threshold.

The present disclosure describes example devices, systems, methods, and media for adaptive scene augmentation for training machine learning models to perform point cloud segmentation and/or object detection.

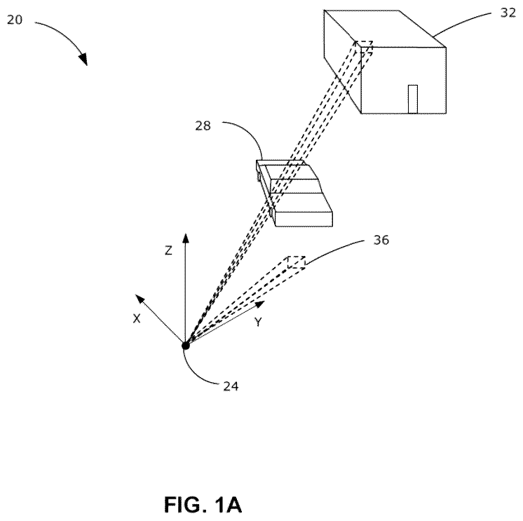

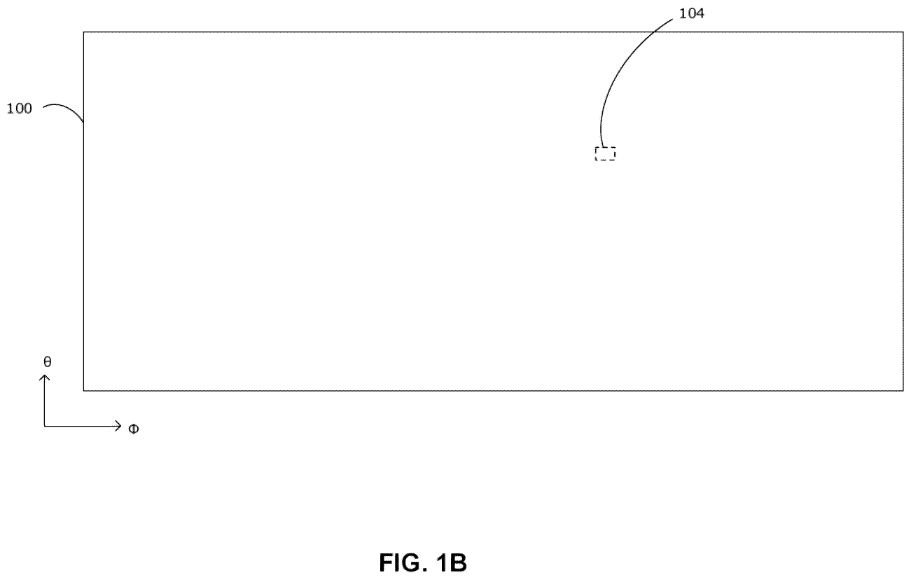

FIG. 1A shows an exemplary 3D environment 20 in which a LiDAR sensor 24 may be used. In this figure, a portion of the environment is captured by the LIDAR sensor, however it will be appreciated that a typical point cloud frame captured by a panoramic LIDAR sensor is typically a 360 degree panoramic view of the environment surrounding the LIDAR sensor, extending out to a full detection range of the LIDAR sensor. One portion of the 3D environment 20 being captured by the LIDAR sensor 24 includes a vehicle 28 and a building 32. Another portion of the 3D environment 20 being captured includes a road surface 36.

FIG. 1B shows a range image 100 generated using a point cloud frame of the 3D environment 20 captured by the LIDAR sensor 24. In the range image 100, points in the point cloud frame captured by the LIDAR sensor 24 are mapped onto a two-dimensional coordinate system, such as azimuth and inclination. The range image 100 includes a number of points, each of which may be represented by a set of coordinates within the range image 100, along with a vector of other values, such as a distance from the LIDAR sensor 24 and an intensity value indicating the reflectivity of the object corresponding to the point. Each point represents a reflection of light emitted by a laser at a point in space relative to the LIDAR sensor 24 corresponding to the point coordinates. The points of the point cloud frame 100 are clustered in space where light emitted by the lasers of the LIDAR sensor 24 are reflected by objects in the environment, thereby resulting in clusters of points corresponding to the surface of the object visible to the LIDAR sensor 24.

A pixel 104 of the range image 100 corresponding to the points being captured in FIG. 1A is also shown. As will be appreciated, the example pixel 104 is not drawn to scale relative to the range image 100, and is shown for illustrative purposes. Typically, the pixel 104 is much smaller relative to the range image 100. Though objects in the range image 100 are represented as 2D idealized figures, due to the error of 3D reconstruction, the 2D surface has a thickness normal to the range image. That is, the points in the pixel 104 can have different depths or distances from the LIDAR sensor 24. For example, the pixel 104 can represent the road surface 36 that can extend along a range distance-wise from the LIDAR sensor 24. These points can be grouped in multiple clusters. This is particularly true where the vehicle 28 and the building 32 of FIG. 1A are both captured in the same pixel 104, but can also be true of the road surface 36.

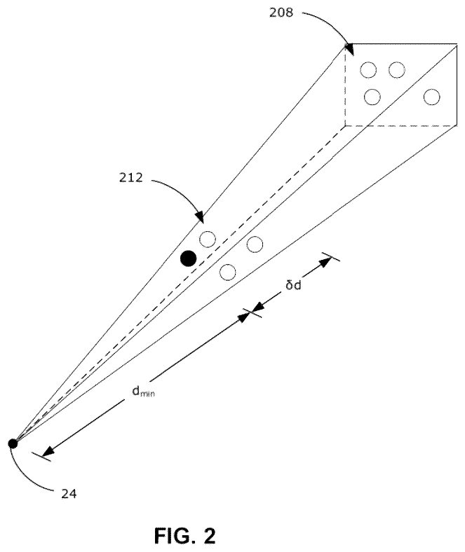

FIG. 2A illustrates the capturing of the points of the point cloud frame within the range image 100 of FIG. 1B. In this example, the pixel 104 contains two separate clusters of points spaced along the distance coordinate, although it should be appreciated that there may be any number of clusters of points within the pixel 104. A first cluster 204 is the cluster of points closest to the LIDAR sensor 24, whereas a second cluster 204 is further away from the LIDAR sensor 24. In this embodiment, a closest point 212, which is a distance of dₘᵢₙ from the LIDAR sensor 24, is used for determining where a first peak begins. The first peak is determined to encompass all points between the first point 212 and all other points within a distance range of (dₘᵢₙ, dₘᵢₙ+δd) from the LIDAR sensor 24. The first peak is determined for each pixel 104 in the range image 100.

In some embodiments, the value of δd can depend on the level of noise. In one specific embodiment,

$$δ d = 2 ( d \cdot {θ}_{e r r} + {r}_{e r r} ) ,$$

where θₑᵣᵣ and rₑᵣᵣ are the attitude and position error (1-sigma) of the GPS-INS system. d is a fixed value of 20 meters. θₑᵣᵣ is expressed in radians. For example, if θₑᵣᵣ is 0.1 deg=0.00175 rad, and rₑᵣᵣ is 0.07 m, then

$$δ d = 2 \times ( 0.00175 \times 20 + 0.07 ) = 0.21 m .$$

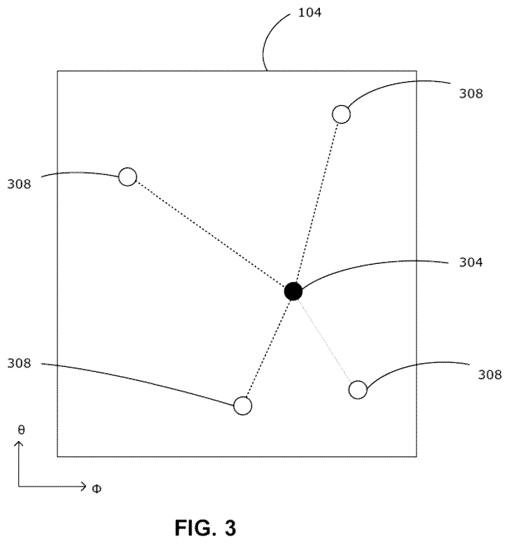

FIG. 3 shows the points of FIG. 2A in the first peak of pixel 104 isolated by discarding the points outside the first peak (that is, the points in cluster 208 in FIG. 2).

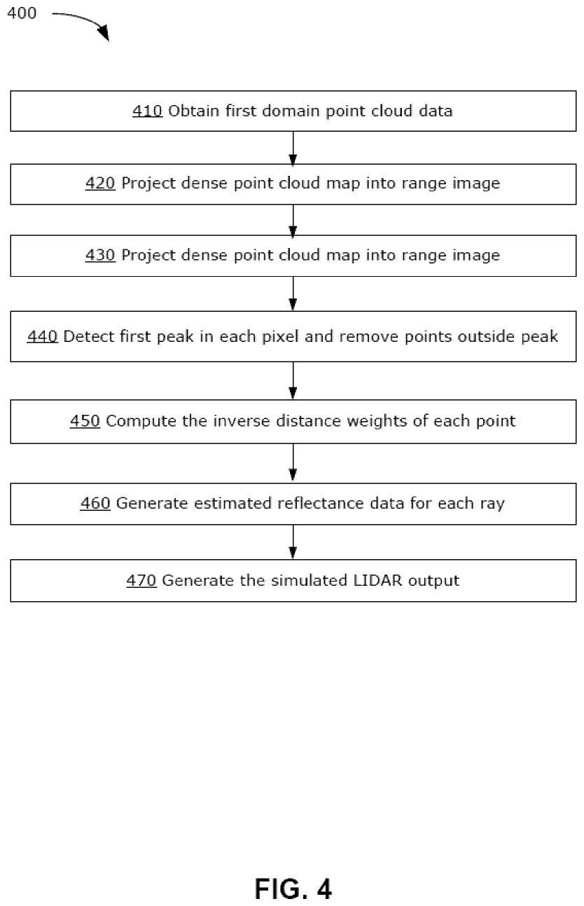

Now with reference to FIGS. 3 and 4, a method 300 for first peak average raycasting in accordance with an embodiment is shown. The method 400 begins at step 410, wherein the first domain point cloud data is obtained from the LIDAR sensor 24. This includes using a LIDAR sensor 24 performing a scan to obtain a point cloud frame. Then, at step 420, a plurality of rays 304 are generated travelling from a LIDAR sensor through the point cloud in a second domain. The LIDAR sensor may have a different configuration than that of the LIDAR sensor 24 of FIG. 1A. At step 430, the points captured by the LIDAR sensor 24 in the point cloud frame are projected into a range image. After the projection is complete, at step 440, a first peak 204 is identified in each pixel 104. To identify the first peak 204 as shown in FIG. 2, the closest point 206 is first found, and its depth is denoted by dₘᵢₙ. The points 308 within a predetermined distance [dₘᵢₙ, dₘᵢₙ+θd] are considered part of the first peak 204, and are kept for further processing. The other points 208 that lie outside of the first peak are discarded.

At step 450, the inverse distance weight of each point 308 in the first peak 204 is calculated in reference to the ray 304 from the LIDAR sensor in the second domain passing through the pixel 104. The points have coordinates [θᵢ, θᵢ] on the axes, denoting the elevation and the azimuth, respectively, of each i-th point 308 in the first peak 204. For each laser beam 304 in the second domain, the inverse distance weighting of the beam is computed as follows.

In determining the inverse distance weights, first, a raw weighting of each point 308 in the first peak in relation to the beam 304 is computed as

$${\tilde{w}}_{i} = \frac{1}{{( {∅}_{l} - {∅}_{i} )}^{2} + {( {θ}_{l} - {θ}_{i} )}^{2}} ,$$

where [θᵢ, θᵢ] represents the elevation and the azimuth of the ray of the second domain.

The value of \tilde{w}ᵢ gives a representation of the straight line distance between the ray 304 and the i-th point 308 in the first peak, irrespective of whether the point 308 is in the positive or negative elevation or azimuth in reference to the laser beam 304. Next, the weighting of each point 308 is normalized relative to the sum of weightings of all points 308 in the first peak:

$${w}_{i} = \frac{{\tilde{w}}_{i}}{{\sum }_{i = 1}^{n} {\tilde{w}}_{i}}$$

The value of wᵢ represents how much of an effect the intensity value xᵢ of the i-th point 308 will have on the ray 304. The ratio weighting value \tilde{w}ᵢ of each point 308 against the sum of all n points 308 is calculated, giving an overall intensity scaling factor for each point 308 in reference to the coordinates of the point 308 and the ray 304.

Finally, at step 460, the overall intensity value Xᵢ for the beam can be calculated as

$${X}_{l} = {\sum }_{i = 1}^{n} {w}_{i} {X}_{i}$$

At step 470, once the estimated reflectance data for each ray has been generated, the simulated LIDAR output can be generated using the estimated reflectance data. This output is an idealized simulation, with much more information and more complete geometry structure than would usually be obtainable though real LIDAR scanning. Further, this calculation can be carried out for multiple rays 304 in each pixel 104, and due to the weighing of each point 308 in the first peak in relation to each other, the output will not generate duplicate coordinates and values.

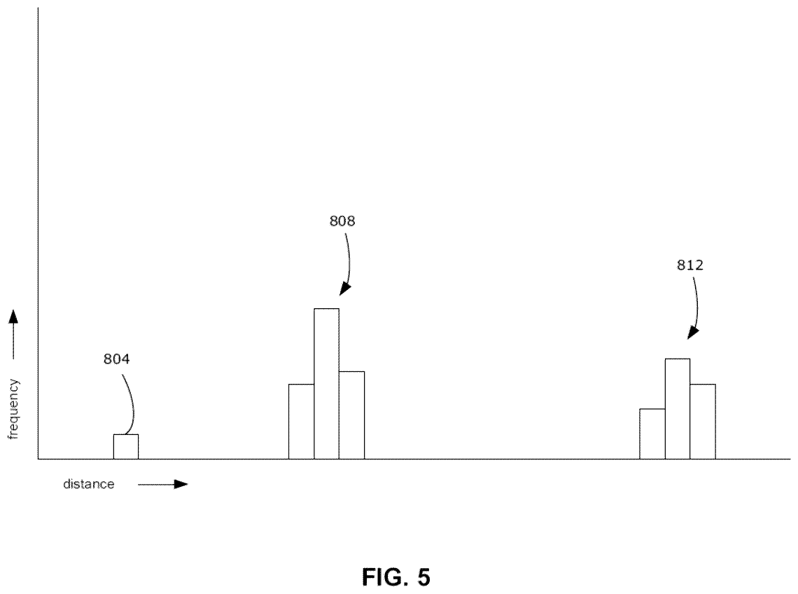

While, in the embodiment described and illustrated above, the points in the first peak of each pixel are determined in a particular manner, other approaches can be employed. For example, the closest cluster having a particular mass of points can be designated as the first peak. FIG. 5 is an exemplary bar graph showing the frequency/density of points in a pixel based on their distance from the LIDAR sensor. The points are grouped into distance bands to facilitate the identification of points having very similar distances from the LIDAR sensor. In one particular embodiment, any group of n points or more within a fixed distance of each other can be considered a peak. Thus, point 804 would not be considered a peak since it is not within the fixed distance of other points. Points 808 and 812 would be considered peaks since these groups of points are sufficiently large and within the desired range of each other, and points 808 would be deemed to be the first peak. In this manner, outliers can be discarded. Any other suitable manner for identifying points within the first/closest peak can be employed. In another example, a first closest cluster of points including at least some portion of all the points in the pixel (e.g., 40%) can be identified as the first peak.

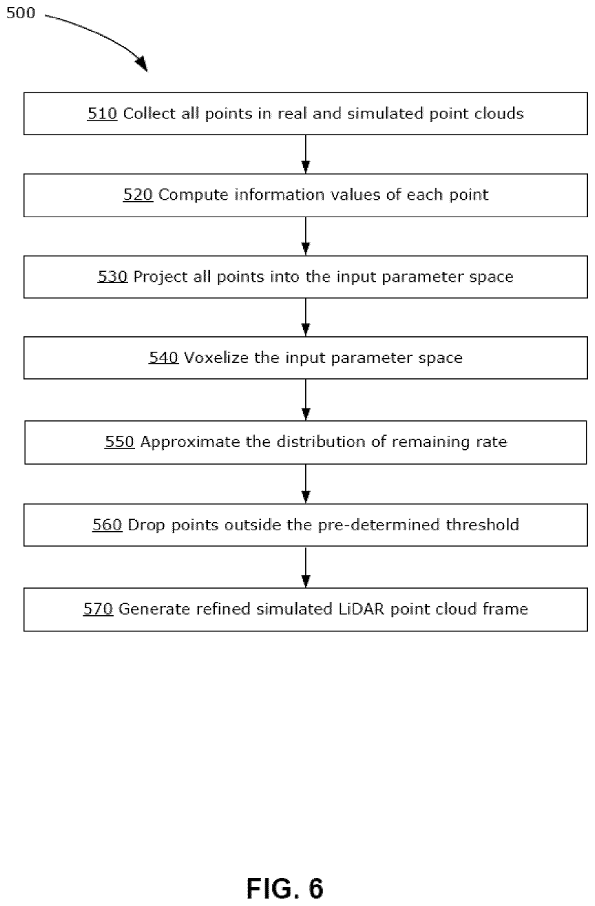

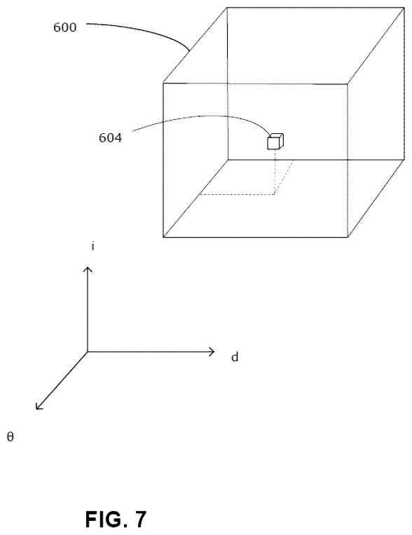

FIG. 6 is a flowchart showing steps of an example method 500 for raydropping to create a more accurate LIDAR simulated 3D environment. First, at step 510, all points from a point cloud frame of both real and simulated LIDAR point clouds are collected, which have the same LIDAR pose. At step 520, the information values of each point are calculated, which includes their coordinate and intensity values. The points are then projected into the input parameter space in step 530, as illustrated by the example in FIG. 7. The input parameter space 600 is mapped onto a 3D coordinate system, containing the coordinate values [d, θ] for each point, as well as intensity value i, which contains partial information about surface reflectance. At step 540, the input parameter space is voxelized, with each voxel 604 containing points from both the real and simulated LIDAR point clouds.

In each voxel 602, the retained point ratio is calculated at step 550 as

$$r = \frac{{N}_{real}}{{N}_{simulation}} ,$$

where r is a function of d, i, and θ.

From the calculated ratio for each voxel 602, a distribution of the ratio in each voxel can be approximated by a multi-layer perceptron (MLP), and this approximated distribution can be used to define the surrogate model of the LIDAR sensor. In determining the retained point ratio of each voxel 604, only voxels that have equal to or more than a predetermined number of simulation points are used to train the MLP, otherwise the calculation of the retained point ratio will not be accurate.

At step 560, voxels with a retained point ratio lower than a predetermined threshold are dropped from the simulated point cloud, leaving a simulated point cloud that more closely resembles the real point cloud. As mentioned previously, this surrogate model is independent of its environment, as there is no geometry information in the input.

Finally, at step 570, a refined simulated point cloud is generated with less noise and more accurate data.

In a present embodiment, during generation of point cloud frame training data, method 400 and method 500 are performed in combination, it will be readily understood that both method 400 and method 500 can be performed independently.

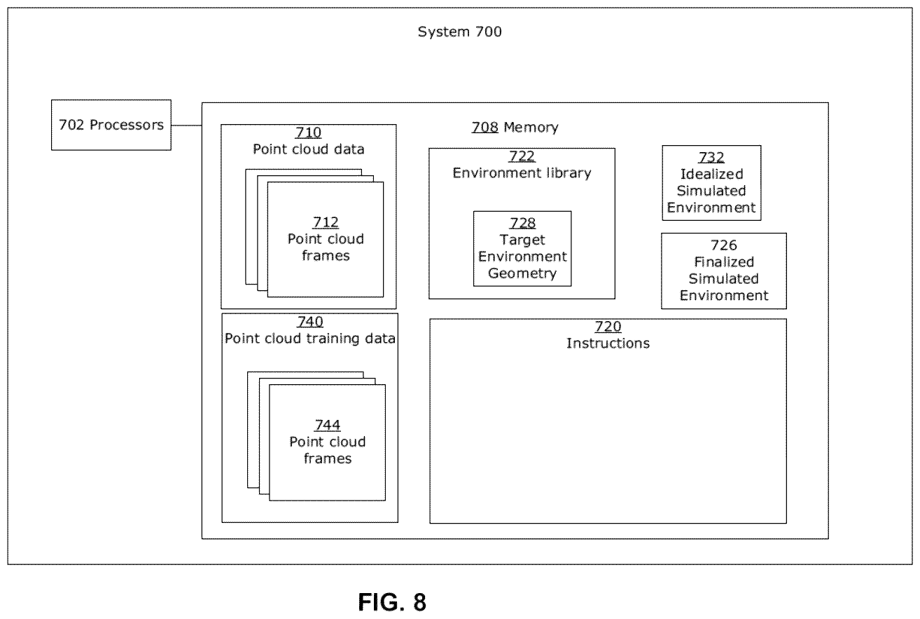

FIG. 8 is a block diagram of a computing system 700 (hereinafter referred to as system 700) for generating point cloud frame training data. Although an example embodiment of the system 700 is shown and discussed below, other embodiments may be used to implement examples disclosed herein, which may include components different from those shown. Although FIG. 8 shows a single instance of each component of the system 700, there may be multiple instances of each component shown.

The system 700 includes one or more processors 702, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 702 may collectively be referred to as a “processor device” or “processor 702”.

The system 700 includes one or more memories 708 (collectively referred to as “memory 708”), which may include a volatile or non-volatile memory (e.g., a flash memory, a random access memory (RAM), and/or a read-only memory (ROM)). The non-transitory memory 708 may store machine-executable instructions for execution by the processor 702, such as to carry out examples described in the present disclosure. A set of machine-executable instructions 720 for generating point cloud frame training data as described herein are stored in the memory 708. The machine-executable instructions 720 include machine-executable instructions for first peak averaging raycasting and for raydropping using a surrogate model of a laser head, as described herein, so that these machine-executable instructions may each be executed by the processor 702 to perform the steps of the methods described. The system 700 may include storage in the memory 708 for an idealized simulated environment 732 as an intermediate step, and a finalized simulated environment 726. The memory 708 may include other machine-executable instructions, such as for implementing an operating system and other applications or functions.

Real point cloud data 710 including a set of labeled point cloud frames 712 can be stored in memory 708, in addition to point cloud training data 740 including a set of point cloud frames 744 generated by the system 700 using the methods described herein.

The memory 708 may also store other data, information, rules, policies, and machine-executable instructions described herein, including an environment library 722 including one or more target environments.

In some examples, the system 700 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the system 700) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 708 to implement data storage, retrieval, and caching functions of the system 700.

The components of the system 700 may communicate with each other via a bus, for example. In some embodiments, the system 700 is a distributed system such as a cloud computing platform and may include multiple computing devices in communication with each other over a network, as well as optionally one or more additional components. The various operations described herein may be performed by different devices of a distributed system in some embodiments.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

Although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The steps (also referred to as operations) in the flowcharts and drawings described herein are for purposes of example only. There may be many variations to these steps/operations without departing from the teachings of the present disclosure. For instance, the steps may be performed in a differing order, or steps may be added, deleted, or modified, as appropriate.

In other embodiments, the same approach described herein can be employed for other modalities.

### General

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A method for generating point cloud frame training data, comprising:
obtaining first domain point cloud data comprising a point cloud frame corresponding to a first LiDAR sensor configuration;
generating a plurality of rays representative of laser trajectories of a second LiDAR sensor configuration;
for each ray:
generating a pixel of a range image by selecting a set of points from the first domain point cloud data based on a certain threshold distance of the points to the ray;
identifying a first peak of the pixel as a subset of the set of points based on a distance value of each point in the subset; and
processing the subset of points, using an averaging function, to generate estimated reflectance data for the ray; and
processing the estimated reflectance data of each ray of the plurality of rays to generate simulated second domain point cloud data comprising a point cloud frame corresponding to the second LiDAR sensor configuration.

2. The method of claim 1, wherein the point cloud frame of the first domain point cloud data is a dense point cloud frame, and wherein obtaining the first domain point cloud data comprises:
obtaining raw first domain point cloud data comprising a raw point cloud frame corresponding to a first LiDAR sensor configuration; and
densifying the raw first domain point cloud data to generate the first domain point cloud data.

3. The method of claim 2, wherein densifying the raw first domain point cloud data comprises constructing a 3D environment based on the raw first domain point cloud data.

4. The method of claim 1, wherein identifying the first peak comprises:
identifying a first point based on the proximity of the first point to the ray and the distance value of the first point; and
identifying a last point of the first peak based on the proximity of the last point to the ray and the distance value of the last point.

5. The method of claim 1, wherein the averaging function comprises a weighted average function based on an inverse distance weighting function wherein each point in the subset is associated with a weight inversely correlated with the proximity of the point to the ray.

6. The method of claim 1, further comprising:
processing the first domain point cloud data and the simulated second domain point cloud data to generate voxelized data comprising coordinate values and intensity values for each point of the first domain point cloud data and each point of the simulated second domain point cloud data found in each of a plurality of voxels;
obtaining, for each voxel, a retained point ratio comprising the ratio of points in the first domain point cloud data to the points in the simulated second domain point cloud data; and
generating a refined simulated point cloud frame comprising a plurality of points of the simulated second domain point cloud data gathered from voxels having a retained point ratio higher than a pre-determined threshold.

7. The method of claim 6, wherein the coordinate values comprise an angle value and a distance value for each point, and the surface reflectance values comprise an intensity value for each point.

8. The method of claim 6, wherein processing the first domain point cloud data and the simulated second domain point cloud data to generate the voxelized data comprises projecting the points from the first domain point cloud data and the points from the simulated second domain point cloud data into an input parameter space, wherein the parameter space comprises possible parameter values that define a mathematical model.

9. The method of claim 8, wherein processing the first domain point cloud data and the simulated second domain point cloud data to generate the voxelized data further comprises voxelizing the input parameter space.

10. The method of claim 6, wherein generating the refined simulated point cloud frame comprises approximating a distribution of a retained point ratio of each voxel by a multi-layer perceptron.

11. The method of claim 10, wherein the approximated distribution of the retained point ratio comprises only voxels that have a number of LiDAR simulated point cloud points above a pre-determined threshold.

12. A method for generating point cloud frame training data, comprising:
obtaining a real LiDAR point cloud and a simulated LiDAR point cloud, each comprising coordinate values and surface reflectance values for each of a plurality of points;
processing the real LiDAR point cloud and the simulated LiDAR point cloud to generate voxelized data comprising coordinate values and intensity values for each point of the real LiDAR point cloud and each point of the simulated LiDAR point cloud found in each of a plurality of voxels;
obtaining, for each voxel, a retained point ratio comprising the ratio of points in the real LiDAR point cloud frame to the points in the simulated LiDAR point cloud frame; and
generating a refined simulated LiDAR simulation point cloud frame comprising a plurality of points of the simulated point cloud frame gathered from voxels having a retained point ratio higher than a pre-determined threshold.

13. The method of claim 12, wherein the coordinate values comprise an angle value and a distance value for each point, and the surface reflectance values comprise an intensity value for each point.

14. The method of claim 12, wherein processing the real LiDAR point cloud and the simulated LiDAR point cloud to generate the voxelized data comprises projecting the points from the real LiDAR point cloud and the points from the simulated LiDAR point cloud into an input parameter space, wherein the parameter space comprises possible parameter values that define a mathematical model.

15. The method of claim 14, wherein processing the real LiDAR point cloud and the simulated LiDAR point cloud to generate the voxelized data further comprises voxelizing the input parameter space.

16. The method of claim 12, wherein generating the refined simulated LiDAR simulation point cloud frame comprises approximating a distribution of a retained point ratio of each voxel by a multi-layer perceptron.

17. The method of claim 16, wherein the approximated distribution of the retained point ratio comprises only voxels that have a number of LiDAR simulated point cloud points above a pre-determined threshold.

18. A system for generating point cloud frame training data, comprising:
one or more processors; and
a memory storing an initial point cloud, and machine-executable instructions which, when executed by the one or more processors, cause the system to:
obtain first domain point cloud data comprising a point cloud frame corresponding to a first LiDAR sensor configuration;
generate a plurality of rays representative of laser trajectories of a second LiDAR sensor configuration;
for each ray:
generate a pixel of a range image by selecting a set of points from the first domain point cloud data based on a certain threshold distance of the points to the ray;
identify a first peak of the pixel as a subset of the set of points based on a distance value of each point in the subset; and
process the subset of points, using an averaging function, to generate estimated reflectance data for the ray; and
process the estimated reflectance data of each ray of the plurality of rays to generate simulated second domain point cloud data comprising a point cloud frame corresponding to the second LiDAR sensor configuration.

19. The system of claim 18, wherein the point cloud frame of the first domain point cloud data is a dense point cloud frame, and wherein obtaining the first domain point cloud data comprises:
obtaining raw first domain point cloud data comprising a raw point cloud frame corresponding to a first LiDAR sensor configuration; and
densifying the raw first domain point cloud data to generate the first domain point cloud data.

20. The system of claim 19, wherein densifying the raw first domain point cloud data comprises constructing a 3D environment based on the raw first domain point cloud data.
